(19) United States
(12) Patent Application Publication
(10) Pub. No.: US 2014/0059974 A1
(43) Pub. Date: Mar. 6, 2014

(54) Polymer Composite Beam with In-Molded Flange Inserts

(71) Applicants: Dale E. POLK, JR., Titusville, FL (US); LRM Industries International, Inc., Rockledge, FL (US)

(72) Inventor: Dale E. Polk, JR., Titusville, FL (US)

(73) Assignee: LRM INDUSTRIES INTERNATIONAL, INC, Rockledge, FL (US)

(21) Appl. No.: 14/114,865

(22) PCT Filed: Apr. 27, 2012
(86) PCT No.: PCT/US2012/035328

§ 371 Date: Oct. 30, 2013

Related U.S. Application Data
(60) Provisional application No. 61/518,249, filed on May 3, 2011.

(51) Int. Cl. E04C 3/28; B29C 45/14

(52) U.S. Cl. CPC E04C 3/28; B29C 45/14008
USPC 52/831; 264/279

(57) ABSTRACT

A solid molded polymer composite beam is described that includes at least a first flange; a second flange; at least one web extending between the two flanges wherein the first and second flanges are configured normal to the at least one web; the first flange and the second flange each contains an in-molded rigid insert in the plane of the flanges normal to the at least one web. The method of manufacture and insertion of the in-molded rigid inserts is also described.

### FIELD

This description relates to molded polymer composite beams and new solutions to increasing their strength in torsion.

### BACKGROUND

Structural beams are used in numerous applications that require rigid strength accompanied by relatively light weight. These include walkways, catwalks, flooring (e.g., temporary aircraft runways), shelving, and interior and/or exterior walls of containers and dwellings. In many applications, the components of a load bearing assembly are fabricated at one location, and then transported to a distant point of use where they are later assembled. Alternatively, fabrication and assembly of the individual panels and supports may be conducted at the same location, followed by shipping the final assembled load bearing article to a distant point of use and optionally further assembly. These structures are required to exhibit a minimum of torsional deformation between loaded and unloaded states.

To meet these types of requirements, such trusses are typically fabricated from materials such as metal, wood, or concrete. While these are typically quite sturdy, they can be undesirably heavy. In addition metal truss structures are subject to corrosion and wood trusses are subject to rot, and as such must typically have protective coatings applied both after manufacture and periodically thereafter as part of a maintenance schedule. Particularly if these coatings are subject to heavy traffic, as in applications such as walkways these protective coatings are usually quickly degraded, exposing the underlying beam or truss structure to degrading environmental conditions.

As transportation of either the individual components or the assembled load bearing assembly to a point of use and/or further assembly is typically required, reducing the weight of the individual components and/or the load bearing assembly is generally desirable for purposes of reducing shipping related fuel costs. Weight reduction is also desirable for purposes of improving the ease of handling the individual components, and the final assembled load bearing assembly.

Weight reduction may be achieved by fabricating individual components from plastic, rather than heavier materials, such as wood and metals. The individual plastic components, and in particular assemblies thereof, typically must, however, possess physical properties, such as strength and load bearing properties (e.g., static and non-static load bearing properties), that are at least equivalent to those of the original components (e.g., metal panels and metal supports). Molded plastic load bearing assemblies are typically prone to failure at the points where the panels themselves and/or the panels and the supports are joined together. Failure typically occurs when the plastic load bearing assemblies are subjected to loads, and in particular non-static loads, such as oscillating loads. To improve physical properties and to reduce the occurrence of load related joint failures, the individual molded plastic panels of the load bearing assembly are typically fabricated so as to weigh at least as much as the original panels (e.g., metal panels) they were designed to replace. To further improve physical properties, the molded plastic load bearing assemblies typically include a redundancy of fasteners, such as screws and/or bolts, at the points where the panels alone and/or the panels and the supports are joined together.

It has been desirable therefore to manufacture beam structures from plastics, and especially from reinforced plastics, such as polymer composites. In order, however, to meet weight support and minimal deflection requirements, even polymer composite support beams may have a weight that is similar to the metal and wood beams they are designed to replace.

It would be desirable to develop molded plastic load bearing assemblies that have reduced weight relative to equivalent load bearing assemblies fabricated from heavier materials, such as metals. It would be further desirable that such newly developed molded plastic load bearing assemblies also possess physical properties, such as static and non-static load bearing properties, that are at least equivalent to those of equivalent load bearing assemblies fabricated from heavier materials, such as metals. Still further, it would be desirable that such newly developed molded plastic load bearing assemblies be easily and efficiently assembled.

There are a number of failure modes of beam structures. In the case of I-beam shaped structures that have a central web and flanges on each end of the web, the neutral axis of such a structure runs along the center of the web. The ideal beam is the one with the least cross-sectional area (and hence requiring the least material) needed to achieve a given section modulus. Since the section modulus depends on the value the moment of inertia, an efficient beam must have most of its material located as far from the neutral axis as possible. The farther a given amount of material is from the neutral axis, the larger is the section modulus and hence a larger bending moment can be resisted.

An aspect to be described is to provide higher strength polymer composite beam structures, and especially to approaches for making the beam structure much more resilient to torsional failure. A common failure mechanism of a beam is failure in torsion. These approaches to be described can be applied to a number of beam structures including I-beams, box beams, flat plates, etc.

### SUMMARY

The solution to the aforementioned problems can be provided by a solid molded polymer composite beam comprising: a first flange; a second flange; at least one web extending between the two flanges wherein the first and second flanges are configured normal to the at least one web; the first flange and the second flange each contains an in-molded rigid insert in the plane of the flanges normal to the at least one web.

In another aspect of the solid molded polymer composite beam the in-molded rigid insert in the flanges comprises a composite structure of two thin rigid inserts in the plane of the flange separated from each other by a filler material.

In another aspect of the solid molded polymer composite beam there is only one web that extends between the two flanges.

In another aspect of the solid molded polymer composite beam the only one web is a truss structure.

In another aspect of the solid molded polymer composite beam with a web truss structure the truss structure is configured so that there is a periodic grooved section normal to the flanges which provides a convenient place to cut the beam into shorter lengths for particular jobs.

In another aspect of the solid molded polymer composite beam rigid metal inserts can be inserted into slots in the flange sections on the ends of adjacent beams and a series of bolts can be inserted through pre-drilled holes, providing a means to rigidly connect adjacent I-beams.

The solution to the aforementioned problems can also be provided by a method of forming a solid molded polymer composite beam with inserts comprising: providing a mold apparatus comprising; a upper mold portion having an exterior pressable surface and an interior surface; a lower mold portion having an exterior pressable surface and an interior surface; a press having a press surface, a portion of the upper mold portion extending beyond the press surface and having an outside the press upper mold portion exterior surface and an outside the press upper mold portion interior surface, a portion of the lower mold portion extending beyond the press surface and having an outside the press lower mold portion exterior surface and an outside the press lower mold portion interior surface; the press being positioned to reversibly position the interior surface of the upper mold portion and the interior surface of the lower mold portion towards each other; the outside the press upper mold portion interior surface and the outside the press lower mold portion interior surface together defining an outside the press internal mold space, when the upper mold portion and the lower mold portion are pressed together; a plate having a first surface and a second surface, the second surface of the plate being opposed to the outside the press upper mold portion exterior surface, the plate being separate from the press; at least one expandable member interposed between the second surface of the plate and the outside the press upper mold portion exterior surface; a plurality of vertical arms attached to opposite sides of the plate and forming a plurality of oppositely paired vertical arms, each vertical arm extending towards the lower mold portion, each vertical arm having a terminal portion having a guide, each pair of oppositely paired vertical arms together forming an aligned pair of guides, each aligned pair of guides being dimensioned to receive reversibly a lateral arm there-through; attaching preconfigured inserts into the lower mold portion into the flange portions of the lower mold portion; introducing a molten composite polymeric material onto the interior surface of the lower mold portion; pressing the upper mold portion and the lower mold portion together by means of the press, and compressing the molten composite polymeric material between the interior surface of the upper mold portion and the interior surface of the lower mold portion, the guide of each vertical arm concurrently being positioned beyond the outside the press lower mold portion exterior surface; inserting the lateral arm through each aligned pair of guides; expanding each expandable member resulting in the plate moving away from the outside the press upper mold portion exterior surface and each lateral arm being brought into compressive contact with the outside the press lower mold portion exterior surface, and correspondingly compressing further the molten composite polymeric material residing within the outside the press internal mold space, thereby forming the molded article.

In another aspect of the method each expandable member is an expandable pillow interposed between the second surface of the plate and the outside the press upper mold portion exterior surface.

In another aspect of the method each expandable member is an expandable tube interposed between the second surface of the plate and the outside the press upper mold portion exterior surface.

### BRIEF DESCRIPTION OF THE DRAWINGS

FIG. 1 is a molded composite polymer beam illustrating an embedded flange insert.

FIG. 2 is a side view of an embodiment of the structure of a flange insert.

FIG. 3 is a top view of a possible embodiment of a flange insert;

FIG. 4 is another view of a molded composite polymer beam illustrating the attachment of one beam to an adjoining beam.

FIG. 5 is an overview of a molding system for preparing molded composite beams.

FIG. 6 is a side view of the lower mold assembly of the expanded mold used in FIG. 5.

FIG. 7 is an end view of the lower mold assembly of the expanded mold used in FIG. 5.

### DETAILED DESCRIPTION

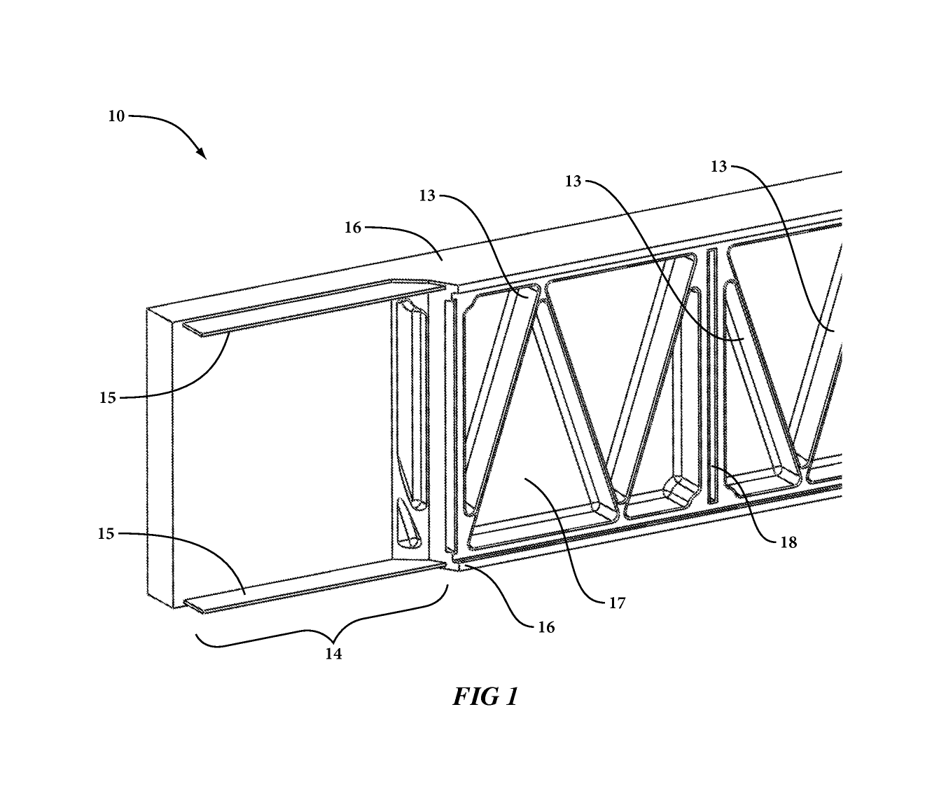

With reference to FIG. 1 of the drawings, there is depicted a molded composite polymer beam 10 representing an embodiment of the solid molded polymer composite beam. The particular beam illustrated is a truss I-beam structure although as mentioned earlier the concept is not limited to truss structures. The truss structure is shown in section 12 as it appears in its final form and is a polymer composite planer truss structure with multiple truss elements 13 configured in triangles. The web areas 17 interposed between the truss elements 13 are made of a solid polymer composite also and are thinner than the flange 16 width. The end section 14 is a cutaway view to show one aspect, in-molded inserts 15 in the top and bottom flange portions 16 of truss I-beam 10. Inserts 15 extend the complete length of the truss beam.

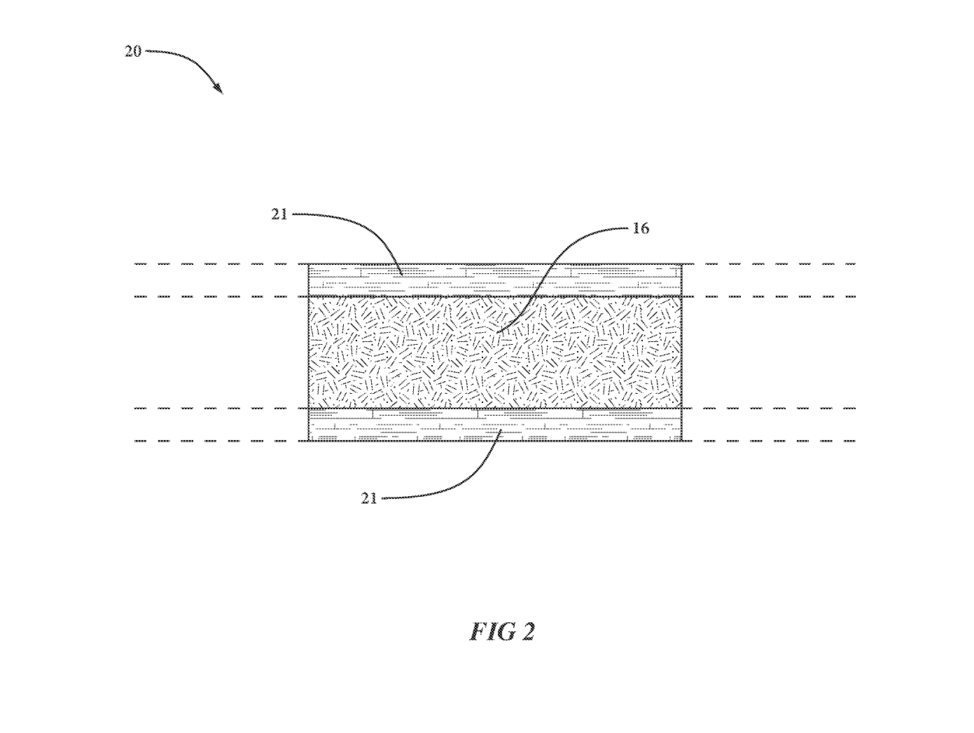

The use of two thin inserts in each flange spatially separated from each other is another aspect of this description. It has been found that the more the thin inserts are separated from each other in the flange the more the moment of inertia is increased and the stronger we can make the beam in torsion. One embodiment of how this can be done is shown in FIG. 2 which illustrates one of the the inserts 20 and shows two thin strips 21 of a rigid material maintained separate from each other by the inclusion of a light weight filler material 22. As only one example one embodiment of steel/wood/steel composite inserts has been found to significantly increase the load bearing capability of the beam while reducing overall weight of the beam structure by enabling the use of less polymer composite material in the remaining structure. The strength of the filler material, in this example wood, only has to be strong enough to maintain the separation of the thin rigid strips 21. In principle this separation could be accomplished without a filler like wood if the separation could be accomplished by filling the region between the two rigid strips by the polymer composite material during manufacture of the beam.

The final structure completely encapsulates the insert in the polymer composite and provides an environmentally tough covering that does not require continuing maintenance coatings for corrosion or rot. Any beam structure with flange elements can be strengthened using this approach.

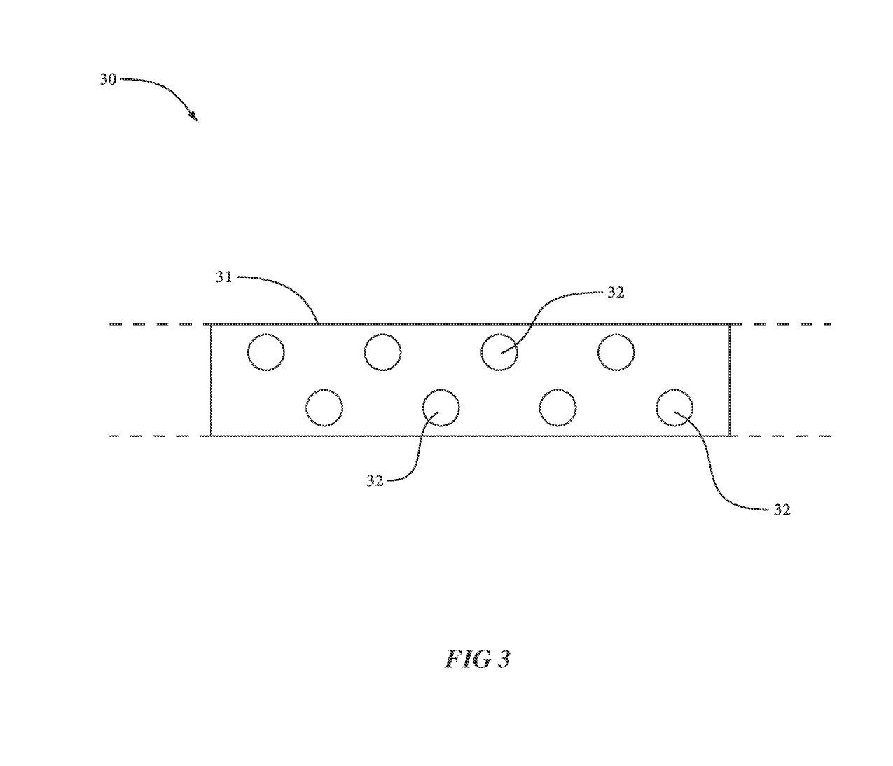

A top view of one of the thin inserts 20 is shown in FIG. 3 to illustrate a further embodiment in which the insert is drilled with holes 32. The holes extend completely through the insert structure and in the case of a structure as in FIG. 2 they extend through all three layers. These holes 32 provide two functions—they allow polymer to flow thru the sandwich during molding, thus reducing molding stresses during molding. In addition to reducing stresses the polymer acts to trap the rigid strips 21 so that they do not slide under loading stress.

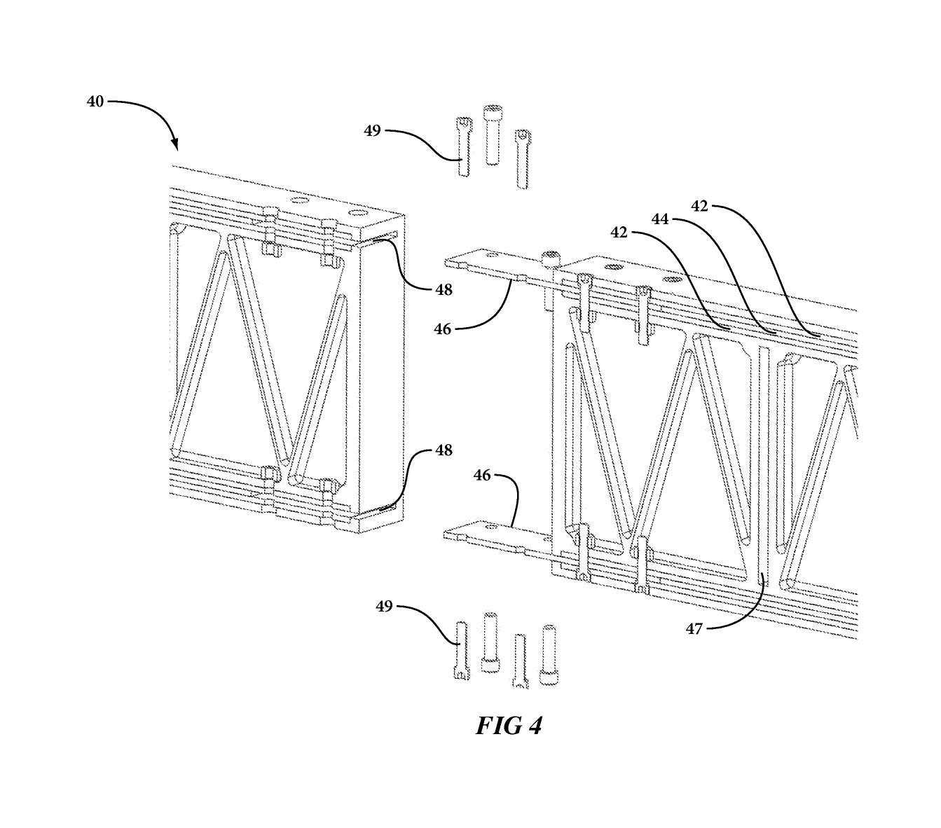

The structure 40 in FIG. 4 is a alternate rendering of the same molded composite polymer truss I-beam of FIG. 1 to better illustrate an additional embodiment for securely joining adjacent beams. The three layer rigid insert described in FIG. 2 can be seen here as rigid strips 42 separated by a filler strip 44. At each end of the adjacent beams there are provided slots 48 extending for a short distance into the flange sections. Rigid metal inserts 46 can then be inserted into slots 48 and a series of bolts 49 can be inserted through pre-drilled holes, providing a means to rigidly connect adjacent I-beams.

Another aspect of the prepared molded composite polymer truss I-beams beams can be seen as numeral 18 in FIG. 1 or numeral 47 of FIG. 4. The truss I-beams 10 can be manufactured in the production method to be described in long sections. But at equal lengths along the truss I-beams, for example every one foot section, a truss groove, such as 18 in FIG. 1, allows a place for a clean cut of the truss I-beam into smaller lengths to fit different requirements.

The Production Method

The completed beam structure, including the flange inserts, can be manufactured in a molding system as described earlier in U.S. application 61/455,046.

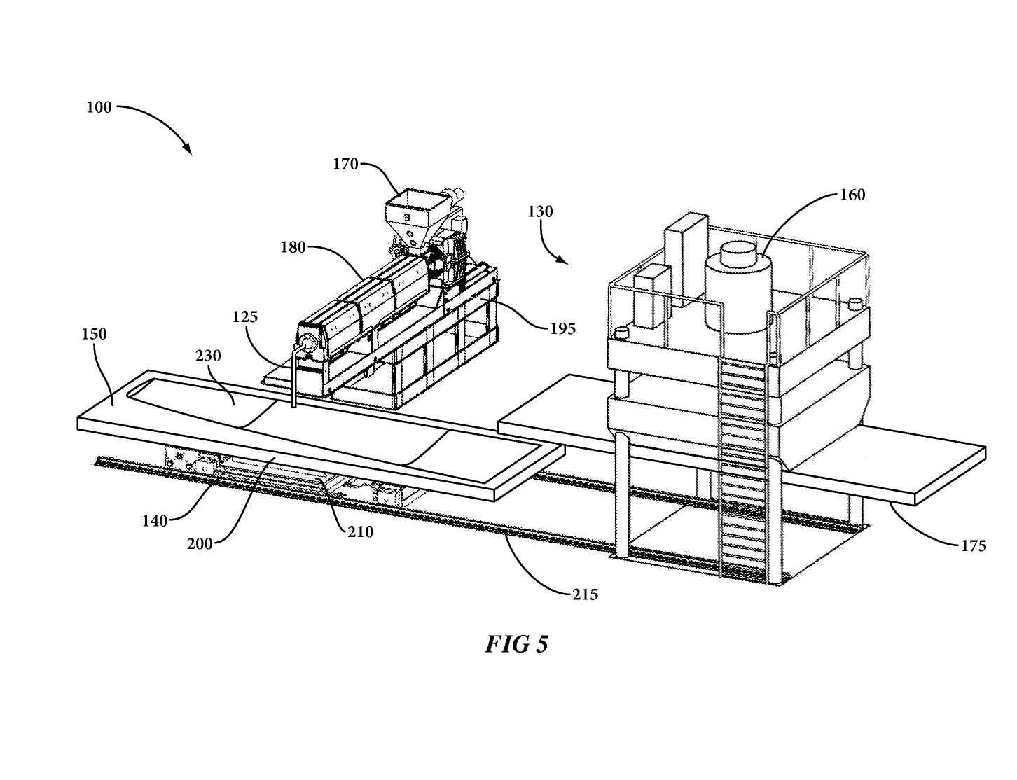

In the embodiment, shown in FIG. 5 a molding system is shown using a press 130 and a moveable mold support (or trolley) 140 movable along a rail system 215. Alternate embodiments for higher productivity can operate with two presses and two trolleys along rail system 215 with a press on each end. The trolley 140 supports an extended lower mold 150. The lower mold has an interior mold surface 230. During the deposition phase the lower mold 150, is located directly below a deposition tool 125 that can take different forms in different embodiments, including an injection die, an injection nozzle, or a dynamic die that can deliver variable amounts of molten composite material. The deposition tool 125 is connected to an injection unit barrel 180 supported by an injection barrel frame 195. A material feed hopper 170 accepts polymeric resin or composite material into an auger section where heaters are heating the polymeric material to a molten state while the auger is feeding it along the length of an injection barrel 180 that can be an extruder or an injection head. Heaters (not shown) along the injection barrel maintain temperature control. At the exit of injection barrel 180 is shown in one embodiment as a deposition tool 125 for feeding the molten composite material precisely onto the lower mold 150. It should be noted that the deposition tool in some embodiments could be as simple as a straight pipe but could also be a (static) sheet die. In other embodiments it can be a dynamic die that supplies variable and controlled amounts of composite material across the die.

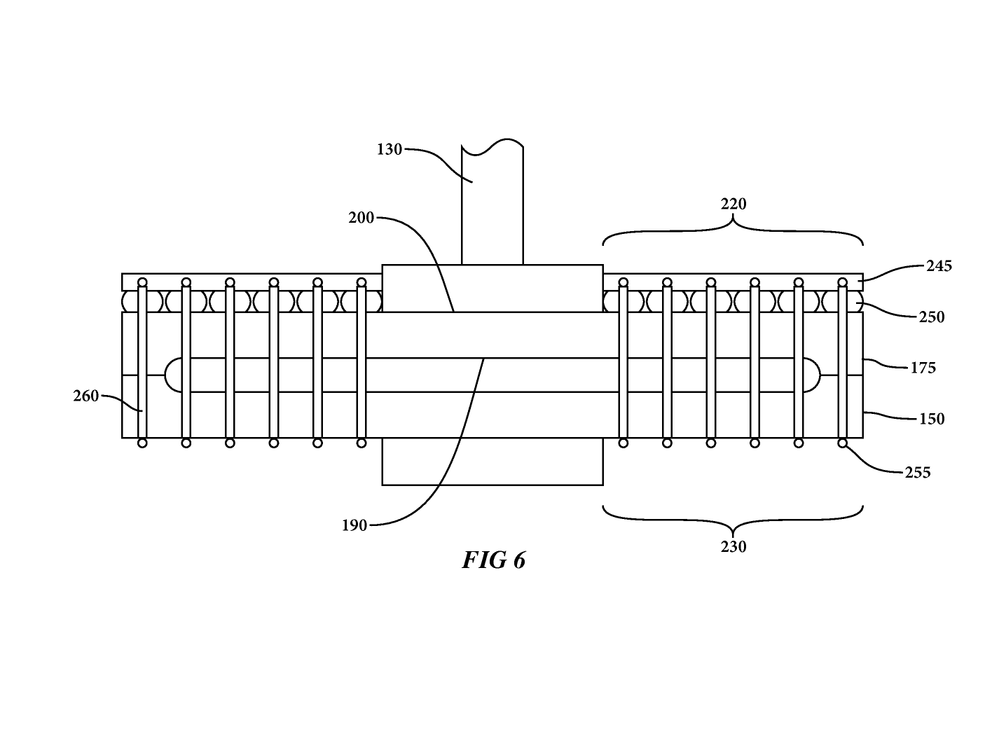

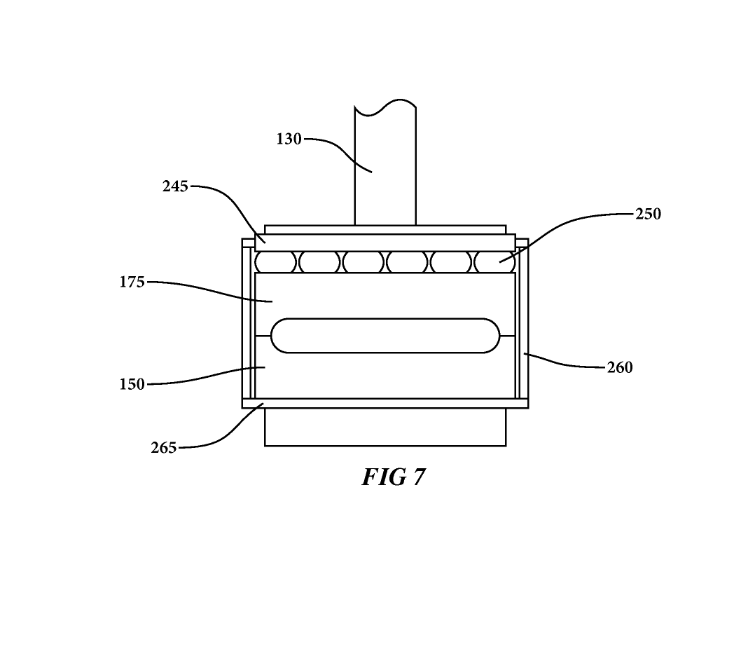

Looking now at FIG. 6 (side view) and FIG. 7 (end view) an upper mold 175 corresponding to the lower mold 150 is shown on the press 130. The upper mold 175 also has an interior mold surface 190 and an exterior pressable mold surface 200. Press 130 has a press area corresponding to the area it exerts its compressive force on the exterior surfaces of upper mold 175 and lower mold 150. The upper mold 175 includes an upper mold outside the press portion 220 that extends beyond the press area. Likewise the lower mold 150 includes a lower mold outside the press portion 230 that extends beyond the press area. Similar outside the press areas exist on the other side of the combined molds.

Extending over a portion of the outside the press area of the upper mold is a plate 245. Between the plate 245 and the exterior surface of upper mold outside the press area 220 is an expandable member 250. As will be explained later the expandable member can be expanded to apply pressure to the outside the press portions of the molding. Expandable member 250 can take a number of forms including an expandable pillow or an expandable tubular material that is deployed between the plate 245 and the exterior surface of upper mold outside the press area.

The molding method begins with filling the cavities 230 of lower mold 150 in a precise manner by controlled movement of trolley 140 under deposition tool 125 accompanied by varying the volumetric flow of composite material from the injection barrel. Precise filling creates a “near net shape” of the molten composite material in the low mold cavities, leading to lower needed compression molding pressures at molding time. After mold filling the lower extended mold is transported via movement of trolley 140 along rails 215 into press 130. In the press the interior mold surface of the upper mold and the interior mold surface of the lower mold are in facing opposition to each other and form an internal mold space. A plurality of vertical arms 260 is attached to opposite sides of plate 245, each vertical arm extending toward of the lower mold portion and each having a guide 255 such as an eyelet and each pair of oppositely paired vertical arms together forming an aligned pair of guides, with each aligned pair of guides dimensioned to receive a lateral or horizontal arm 265. When the press is used to begin pressing the upper and lower mold portions together the guides 255 of each vertical arm 260 are positioned below the lower mold portion exterior surface and a lateral or horizontal arm 265 is inserted through each aligned pair of guides.

With the vertical and horizontal arms in place and connected the expandable member 250 is then expanded. The plate 245 is thus moved away from the outside the press upper mold portion, thereby further compressing the composite material residing within the outside the mold internal mold space. The expandable member expansion is controlled so that the compressive force within the press surface and the outside the press pressures are substantially equivalent.

This technique thus allows the compression molding of very large parts that lie outside the press envelope of a press.

Returning to FIG. 5 press 130 contains an upper mold required for compression molding of the parts. It has a hydraulic ram 160 for applying compressive force. With respect to the complete lower mold assembly, in a first embodiment there is a first trolley that rides on rails 215. The trolley can move back and forth below deposition tool 125 in a direction (the x direction) that is parallel to rails 215.

To achieve control of material deposition in the “y” direction, that is perpendicular to the rails, the system has a second movable structure (the second trolley) with a table guide that rides on y-direction tracks above the first trolley. The combination of being able to control both x and y direction movement by use of one trolley riding on the other gives control of the x-y plane. When this is combined with the ability to control the volumetric flow of molten composite material emanating from deposition tool 125, this gives in effect 3-axis control and the capability to create “near net shape” parts on the lower mold before the upper mold is applied for compression. In a second embodiment there a single trolley on which the lower mold rides. This allows control in the x-direction only and control in the y (perpendicular to the tracks 215) direction is achieved by use of a dynamic die that can deliver controlled amounts of composite material across the mold in the y-direction. The dynamic die is described in U.S. Pat. Nos. 7,208,219; 6,900,547; 6,869,558; and 6,719,551. For purposes of this description the following description of the molding process will be based on the two-trolley system that can be moved in both the x and y directions.

Turning now to the composite material feed system; FIG. 5 show a possible embodiment of a feed system. A material feed hopper 170 accepts polymeric resin or composite material into an auger section where heaters are heating the polymeric material to a molten state while the auger is feeding it along the length of an injection barrel 180 that can be an extruder or an injection molding head. A screw motor with a cooling fan drives a hydraulic injection unit, with a cooling fan. Heaters (not shown) along the injection barrel maintain temperature control. At the exit of the injection barrel is shown in one embodiment as an injection nozzle 125 for feeding the molten composite material 240 precisely onto the lower mold 230. It should be noted that the injection nozzle in some embodiments could be as simple as a straight pipe, but could also be a sheet die.

The combination of x-y control of the mold base and control of the volumetric flow rate of the molten material allows precise deposition of the molten composite material into the desired location in the cavities 230 of lower mold 150 so that a “near net shape” of the molded part is created, including sufficient molten material deposited in locations with deeper cavities in the lower mold. Upon completion of the “near net shape” molten deposition of the composite material, the filled half of the matched mold is mechanically transferred by means of the first trolley system along rails 215 to compression press 130 for addition of and connection of the vertical 260 and horizontal arms 265 for the outside the press final consolidation of the molded part. Since the filled half of the mold represents a “near net shape” of the final molded part, the final compression molding step with the other half of the matched mold can be accomplished at very low pressures (<2000 psi) and with minimal movement of the molten composite mixture.

The extrusion-molding process includes a computer-controlled extrusion system (not shown) that integrates and automates material blending or compounding of the matrix and reinforcement components to dispense a profiled quantity of molten composite material that gravitates into the lower half of a matched mold, the movement of which is controlled while receiving the material, and a compression molding station for receiving the lower half of the mold for pressing the upper half of the mold against the lower half to form the desired structure or part. The lower half of the matched-mold discretely moves in space and time at varying speeds and in a back and fourth movement and in both the x and y directions to enable the deposit of material precisely and more thickly at slow speed and more thinly at faster speeds. The polymeric apparatus described above is one embodiment for practicing the extrusion-molding process. Unprocessed resin (which may be any form of regrind or pleated thermoplastic or, optionally, a thermoset epoxy) is the matrix component fed into a feeder or hopper of the extruder, along with reinforcement fibers greater than about 12 millimeters in length. The composite material may be blended and/or compounded by the injection barrel 180, and “intelligently” deposited onto the lower mold half 150 by controlling the output of the injection barrel 180 and the movement of the lower mold half 150 in both the x and y directions relative to the position of deposition tool 125. The lower section of the matched-mold receives precise amounts of extruded composite material, and is then moved into the compression molding station.

The software and computer controllers needed to carry out this computer control encompass many known in the art. Techniques of this disclosure may be accomplished using any of a number of programming languages. Suitable languages include, but are not limited to, BASIC, FORTRAN, PASCAL, C, C++, C#, JAVA, HTML, XML, PERL, etc. An application configured to carry this out may be a stand-alone application, network based, or wired or wireless Internet based to allow easy, remote access. The application may be run on a personal computer, a data input system, a PDA, cell phone or any computing mechanism.

The first trolley may further include wheels (not shown) that provide for translation along rail 215. The rail 215 enables the first trolley to roll beneath the deposition tool 125 and into the press 130. The press operates to press an upper mold into the lower mold. Even though the principles of this embodiment provide for reduced force for the molding process than conventional thermoplastic molding processes due to the composite material 240 layer being directly deposited from deposition tool 125 to the lower mold, the force applied by the press is still sufficient to damage the wheels if left in contact with the rail. Therefore, the wheels may be selectively engaged and disengaged with an upper surface of the press. In one embodiment, the first trolley is raised by inflatable tubes (not shown) so that when the tubes are inflated, the wheels engage the rails 215 so that the trolley is movable from under deposition tool 125 to the press. When the tubes are deflated, the wheels are disengaged so that the body of the trolley is seated on the upper surface of a base of the press. It should be understood that other actuated structural components might be utilized to engage and disengage the wheels from supporting the trolley.

The computer based controller (not shown) is electrically coupled to the various components that form the molding system or could operate in a wireless manner. The controller is a processor-based unit that operates to orchestrate the forming of the structural parts. In part, the controller operates to control the composite material being deposited on the lower mold by controlling temperature of the composite material, volumetric flow rate of the extruded composite material, and the positioning and rate of movement of the lower mold via the two trolley x-y system to receive the extruded composite material. The controller is further operable to control the heaters that heat the polymeric materials. The controller may control the rate of the auger to maintain a substantially constant flow of composite material through the injection barrel 180 and into deposition tool 125. Alternatively, the controller may alter the rate of the auger to alter the volumetric flow rate of the composite material from the injection barrel. The controller may further control heaters in the extruder. Based on the structural part being formed, a predetermined set of parameters may be established for the deposition tool to apply the extruded composite material to the lower mold. The parameters may also define how the movement of the two trolley system is positionally synchronized with the volumetric flow rate of the composite material in accordance with the cavities on the lower mold that the define the structural part being produced.

Upon completion of the extruded composite material being applied to the lower mold, the controller drives the first trolley into the press. The controller then signals a mechanism (not shown) to disengage the wheels from the track 215 as described above so that the press 130 can force the upper mold against the lower mold without damaging the wheels. The plurality of vertical arms are then connected via the lateral arms and the inflatable member is inflated to apply compressive force on the outside the box portion of the mold.

Note that the extrusion-molding system of FIG. 1 is configured to support one press 130 that is operable to receive the trolley assembly that supports the lower mold to form the structural part. It should be understood that two two-trolley systems might be supported by the tracks or rails 215 with a press on each end so as to provide for forming multiple structural components by a single injection barrel and deposition tool. Note also that while wheels and rails may be utilized to provide movement for the trolley mechanisms as described in one embodiment, it should be understood that other movement mechanisms may be utilized to control movement for the two trolley combination. For example, a conveyer, suspension, or track drive system may be utilized to control movement for the trolley. The concepts described herein anticipates any of those embodiments.

The controller may also be configured to support multiple structural parts so that the extrusion-molding system may simultaneously form the different structural parts via different presses. Because the controller is capable of storing parameters operable to form multiple structural parts, the controller may simply alter control of the injection unit and trolleys by utilizing the parameters in a general software program, thereby providing for the formation of two different structural parts using a single injection unit. It should be understood that additional presses and trolleys might be utilized to substantially simultaneously produce more structural parts via a single extruder.

By providing for control of the dual trolley system and reinforced composite material being applied to the lower mold in precise “near net shapes”, any pattern may be formed on the lower mold, from a thick continuous layer to a thin outline of a circle or ellipse, any two-dimensional shape that can be described by discrete mathematics can be traced with material. Additionally, because control of the volume of composite material deposited on a given area exists, three-dimensional patterns may be created to provide for structural components with deep draft and/or hidden ribs, for example, to be produced. Once the structural part is cooled, ejectors may be used to push the consolidated material off of the mold. The principles described herein may be designed so that two or more unique parts may be produced simultaneously, thereby maximizing production efficiency by using a virtually continuous stream of composite material.

In use, the process operates as follows. A polymeric material is heated to form molten polymeric material and blended with a fiber to form a composite material. The molten composite material is then delivered through injection barrel 180 and then extruded through deposition tool 125 to gravitate onto lower mold 150. The lower mold 150 may be moved in space and time in the x-y directions while receiving the composite material to conform the amount of composite material required in the cavity defined by the lower and upper molds. The upper mold 175 is then pressed to the lower mold 150 to press the composite material into the lower and upper molds and form the article. When this is done the vertical arms 260, attached to plate 245 and each with a guide 255 are extended to a point below lower mold 150 so that a lateral arm 265 can be inserted and connected through each aligned pair of guides on each side of the mold. The expandable member 250, located between plate 245 and the exterior surface of the upper mold is then expanded, resulting in moving the plate 245 away from the outside of the upper mold portion exterior surface and thus compressing further the composite material residing within the outside of the press internal mold space, thereby forming the molded article. In this process the fibers may be long strands of fiber formed of glass or other stiffening material utilized to form large structural parts. For example, fiber lengths of 12 millimeters up to 100 millimeters or more in length may be utilized in forming the structural parts.

Insertion Technique

The truss I-beams, I-beams, or box beams described earlier can be formed using composite material having blended fibers to provide most of the strength. But an additional significant improvement in strength, as described before, can be added by the insertion of stiffening elements in the flange portion of the beams.

The production process for inserting the stiffening elements previously described begins by configuring the insert in either the lower or upper mold. The molten extruded composite material is deposited on the lower mold 230. The extruded composite material is formed around the insert to secure the insert into the structural part being formed.

If any supports are used to configure the insert in the lower or upper mold, then the supports are removed. The supports, which may be actuator controlled, simple mechanical pins, or other mechanism capable of supporting the insert during deposition of the extruded composite material onto the lower mold, are removed before the extruded composite material layer is hardened. The extruded composite material layer may be hardened by natural or forced cooling during pressing, vacuuming, or other operation to form the structural part. By removing the supports prior to the extruded composite material layer being hardened, gaps produced by the supports may be filled in, thereby leaving no trace of the supports or weak spots in the structural part. Then the structural part with the insert embedded therein is removed from the mold.

In an alternate embodiment, the stiffening insert is encapsulated with multiple layers of material of varying thickness by be depositing one on top of the other utilizing the claimed extrusion-molding system. Specifically, a first layer of polymeric material is extruded into a lower mold, following which a second layer of the same or different polymeric material is layered on top of the first layer. In certain embodiments, an insert may be placed on top of the first extruded layer prior to or instead of layering the first layer with a second extruded layer. This form of “layering” can facilitate the formation of a structure having multiple layers of polymeric material, of the same or different composition, and layers of different inserted materials.

The beam structures are independently fabricated from a polymer composite material. The polymer composite materials may in each case be independently selected from thermoset plastic materials, thermoplastic materials and combinations thereof. As used herein and in the claims the term “thermoset plastic material” and similar terms, such as “thermosetting or thermosetable plastic materials” means plastic materials having or that form a three dimensional crosslinked network resulting from the formation of covalent bonds between chemically reactive groups, e.g., active hydrogen groups and free isocyanate groups, or between unsaturated groups.

Thermoset plastic materials from which the plastic material may be independently selected, include those known to the skilled artisan, e.g., crosslinked polyurethanes, crosslinked polyepoxides, crosslinked polyesters and crosslinked polyunsaturated polymers. The use of thermosetting plastic materials typically involves the art-recognized process of reaction injection molding. Reaction injection molding typically involves, as is known to the skilled artisan, injecting separately, and preferably simultaneously, into a mold, for example: (i) an active hydrogen functional component (e.g., a polyol and/or polyamine); and (ii) an isocyanate functional component (e.g., a diisocyanate such as toluene diisocyanate, and/or dimers and trimers of a diisocyanate such as toluene diisocyanate). The filled mold may optionally be heated to ensure and/or hasten complete reaction of the injected components.

As used herein and in the claims, the term “thermoplastic material” and similar terms, means a plastic material that has a softening or melting point, and is substantially free of a three dimensional crosslinked network resulting from the formation of covalent bonds between chemically reactive groups, e.g., active hydrogen groups and free isocyanate groups. Examples of thermoplastic materials from which the plastic material of the elongated lower portion, the elongated upper portion and each elongated flange may be independently selected include, but are not limited to, thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polyolefins, thermoplastic (meth)acrylates, thermoplastic acrylonitrile-butadiene-styrene, thermoplastic styrene-acrylonitrile, thermoplastic acrylonitrile-stryrene-acrylate and combinations thereof (e.g., blends and/or alloys of at least two thereof).

In some embodiments, the thermoplastic materials are independently selected from thermoplastic polyolefins. As used herein and in the claims, the term “polyolefin” and similar terms, such as “polyalkylene” and “thermoplastic polyolefin,” means polyolefin homopolymers, polyolefin copolymers, homogeneous polyolefins and/or heterogeneous polyolefins. For purposes of illustration, examples of a polyolefin copolymers include those prepared from ethylene and one or more C₃-C₁₂ alpha-olefins, such as 1-butene, 1-hexene and/or 1-octene.

The polyolefins, from which the thermoplastic material of the elongated lower portion, the elongated upper portion and each elongated flange may in each case be independently selected, include heterogeneous polyolefins, homogeneous polyolefins, or combinations thereof. The term “heterogeneous polyolefin” and similar terms means polyolefins having a relatively wide variation in: (i) molecular weight amongst individual polymer chains (i.e., a polydispersity index of greater than or equal to 3); and (ii) monomer residue distribution (in the case of copolymers) amongst individual polymer chains. The term “polydispersity index” (PDI) means the ratio of M_{W}/Mₙ, where M_{W} means weight average molecular weight, and Mₙ means number average molecular weight, each being determined by means of gel permeation chromatography (GPC) using appropriate standards, such as polyethylene standards. Heterogeneous polyolefins are typically prepared by means of Ziegler-Natta type catalysis in heterogeneous phase.

The term “homogeneous polyolefin” and similar terms means polyolefins having a relatively narrow variation in: (i) molecular weight amongst individual polymer chains (i.e., a polydispersity index of less than 3); and (ii) monomer residue distribution (in the case of copolymers) amongst individual polymer chains. As such, in contrast to heterogeneous polyolefins, homogeneous polyolefins have similar chain lengths amongst individual polymer chains, a relatively even distribution of monomer residues along polymer chain backbones, and a relatively similar distribution of monomer residues amongst individual polymer chain backbones. Homogeneous polyolefins are typically prepared by means of single-site, metallocene or constrained-geometry catalysis. The monomer residue distribution of homogeneous polyolefin copolymers may be characterized by composition distribution breadth index (CDBI) values, which are defined as the weight percent of polymer molecules having a comonomer residue content within 50 percent of the median total molar comonomer content. As such, a polyolefin homopolymer has a CDBI value of 100 percent. For example, homogenous polyethylene/alpha-olefin copolymers typically have CDBI values of greater than 60 percent or greater than 70 percent. Composition distribution breadth index values may be determined by art recognized methods, for example, temperature rising elution fractionation (TREF), as described by Wild et al, Journal of Polymer Science, Poly. Phys. Ed., Vol. 20, p. 441 (1982), or in U.S. Pat. No. 4,798,081, or in U.S. Pat. No. 5,089,321.

The plastic material of the elongated lower portion, the elongated upper portion and each elongated flange may in each case independently and optionally include a reinforcing material selected, for example, from glass fibers, glass beads, carbon fibers, metal flakes, metal fibers, polyamide fibers (e.g., KEVLAR polyamide fibers), cellulosic fibers, nanoparticulate clays, talc and mixtures thereof. If present, the reinforcing material is typically present in a reinforcing amount, e.g., in an amount of from 5 percent by weight to 60 or 70 percent by weight, based on the total weight of the plastic material. The reinforcing fibers, and the glass fibers in particular, may have sizings on their surfaces to improve miscibility and/or adhesion to the plastic materials into which they are incorporated, as is known to the skilled artisan.

In one embodiment, the reinforcing material is in the form of fibers (e.g., glass fibers, carbon fibers, metal fibers, polyamide fibers, cellulosic fibers and combinations of two or more thereof). The fibers typically have lengths (e.g., average lengths) of from 0.5 inches to 4 inches (1.27 cm to 10.16 cm). The elements of the beams described herein may independently include fibers having lengths that are at least 50 or 85 percent of the lengths of the fibers that are present in the feed materials from which the molded support beam is (or portions thereof are) prepared, such as from 0.25 inches to 2 or 4 inches (0.64 cm to 5.08 or 10.16 cm). The average length of fibers present in the molded support beam (or portions thereof) may be determined in accordance with art recognized methods.

Fibers are typically present in the plastic materials in amounts independently from 5 to 70 percent by weight, 10 to 60 percent by weight, or 30 to 50 percent by weight (e.g., 40 percent by weight), based on the total weight of the plastic material (i.e., the weight of the plastic material, the fiber and any additives). Accordingly, the beams so molded may each independently include fibers in amounts of from 5 to 70 percent by weight, 10 to 60 percent by weight, or 30 to 50 percent by weight (e.g., 40 percent by weight), based on the total weight of the particular portion (or combinations of portions thereof that include reinforcing fibers).

The fibers may have a wide range of diameters. Typically, the fibers have diameters of from 1 to 20 micrometers, or more typically from 1 to 9 micrometers. Generally each fiber comprises a bundle of individual filaments (or monofilaments). Typically, each fiber is composed of a bundle of 10,000 to 20,000 individual filaments.

Typically, the fibers are uniformly distributed throughout the plastic material. During mixing of the fibers and the plastic material, the fibers generally form bundles of fibers typically comprising at least 5 fibers per fiber bundle, and preferably less than 10 fibers per fiber bundle. While not intending to be bound by theory, it is believed based on the evidence at hand, that fiber bundles containing 10 or more fibers may result in a molded support beam having undesirably reduced structural integrity. The level of fiber bundles containing 10 or more fibers per bundle may be quantified by determining the Degree of Combing present within a molded article. The number of fiber bundles containing 10 or more fibers per bundle is typically determined by microscopic evaluation of a cross section of the molded article, relative to the total number of microscopically observable fibers (which is typically at least 1000). The Degree of Combing is calculated using the following equation: 100×((number of bundles containing 10 or more fibers)/(total number of observed fibers)). Generally, the molded support beam (or portions thereof) has/have a Degree of Combing of less than or equal to 60 percent, and typically less than or equal to 35 percent.

In addition or alternatively to reinforcing material(s), the plastic materials of the elongated lower portion, the elongated upper portion and each elongated flange may in each case independently and optionally include one or more additives. Additives that may be present in the plastic materials of the various portions of the molded support beam include, but are not limited to, antioxidants, colorants, e.g., pigments and/or dyes, mold release agents, fillers, e.g., calcium carbonate, ultraviolet light absorbers, fire retardants and mixtures thereof. Additives may be present in the plastic material of each portion of the molded support beam in functionally sufficient amounts, e.g., in amounts independently from 0.1 percent by weight to 10 percent by weight, based on the total weight of the particular plastic material.

The polymer composite beams structure may be prepared by art-recognized methods, including, but not limited to, injection molding, reaction injection molding, compression molding and combinations thereof. The molded support beam may be fabricated by a compression molding process that includes: providing a compression mold comprising a lower mold portion and an upper mold portion; forming (e.g., in an extruder) a molten composition comprising plastic material and optionally reinforcing material, such as fibers; introducing, by action of gravity, the molten composition into the lower mold portion; compressively contacting the molten composition introduced into the lower mold portion with the interior surface of the upper mold portion; and removing the molded support beam from the mold. The lower mold portion may be supported on a trolley that is reversibly moveable between: (i) a first station where the molten composition is introduced therein; and (ii) a second station where the upper mold portion is compressively contacted with the molten composition introduced into the lower mold portion.

The lower mold portion may be moved concurrently in time and space (e.g., in x-, y- and/or z-directions, relative to a plane in which the lower mold resides) as the molten composition is gravitationally introduced therein. Such dynamic movement of the lower mold portion provides a means of controlling, for example, the distribution, pattern and/or thickness of the molten composition that is gravitationally introduced into the lower mold portion. Alternatively, or in addition to movement of the lower mold portion in time and space, the rate at which the molten composition is introduced into the lower mold portion may also be controlled. When the molten composition is formed in an extruder, the extruder may be fitted with a terminal dynamic die having one or more reversibly positionable gates through which the molten composition flows before dropping into the lower mold portion. The rate at which the molten composition is gravitationally deposited into the lower mold portion may be controlled by adjusting the gates of the dynamic die.

The compressive force applied to the molten plastic composition introduced into the lower mold portion is typically from 25 psi to 550 psi (1.8 to 38.7 Kg/cm²), more typically from 50 psi to 400 psi (3.5 to 28.1 Kg/cm²), and further typically from 100 psi to 300 psi (7.0 to 21.1 Kg/cm²). The compressive force applied to the molten plastic material may be constant or non-constant. For example, the compressive force applied to the molten plastic material may initially be ramped up at a controlled rate to a predetermined level, followed by a hold for a given amount of time, then followed by a ramp down to ambient pressure at a controlled rate. In addition, one or more plateaus or holds may be incorporated into the ramp up and/or ramp down during compression of the molten plastic material. The molded beams may, for example, be prepared in accordance with the methods and apparatuses described in U.S. Pat. Nos: 6,719,551; 6,869,558; and 6,900,547.

In an embodiment, the elongated support tube is fabricated from a material selected from thermoset materials, thermoplastic materials, metals and combinations thereof. In a particular embodiment, the elongated support tube is fabricated from at least one metal. Metals from which the elongated support tube may be fabricated include, but are not limited to, iron, steel, nickel, aluminum, copper, titanium and combinations thereof.

The development has been described with reference to specific details of particular embodiments thereof. It is not intended that such detailed be regarded as limitations upon the scope of the invention except insofar as and to the extent that they are included in the accompanying claims.

What is claimed is:

1. A solid molded polymer composite beam comprising:
a. a first flange;
b. a second flange;
c. at least one web extending between the two flanges
d. wherein the first and second flanges are configured normal to the at least one web;
e. the first flange and the second flange each contains an in-molded rigid insert in the plane of the flanges normal to the at least one web.

2. The solid molded polymer composite beam of claim 1 wherein the in-molded rigid insert in the flanges comprises a composite structure of two thin rigid inserts in the plane of the flange separated from each other by a filler material.

3. The solid molded polymer composite beam of claim 1 wherein only one web extends between the two flanges.

4. The solid molded polymer composite beam of claim 2 wherein only one web extends between the two flanges.

5. The solid molded polymer composite beam of claim 4 wherein the only one web is a truss structure.

6. A method of forming a solid molded polymer composite beam with inserts comprising:
a. providing a mold apparatus comprising;
i. a upper mold portion having an exterior pressable surface and an interior surface;
ii. a lower mold portion having an exterior pressable surface and an interior surface;
iii. a press having a press surface, a portion of said upper mold portion extending beyond said press surface and having an outside the press upper mold portion exterior surface and an outside the press upper mold portion interior surface, a portion of said lower mold portion extending beyond said press surface and having an outside the press lower mold portion exterior surface and an outside the press lower mold portion interior surface;
iv. said press being positioned to reversibly position said interior surface of said upper mold portion and said interior surface of said lower mold portion towards each other;
v. said outside the press upper mold portion interior surface and said outside the press lower mold portion interior surface together defining an outside the press internal mold space, when said upper mold portion and said lower mold portion are pressed together;
vi. a plate having a first surface and a second surface, said second surface of said plate being opposed to said outside the press upper mold portion exterior surface, said plate being separate from said press;
vii. at least one expandable member interposed between said second surface of said plate and said outside the press upper mold portion exterior surface;
viii. a plurality of vertical arms attached to opposite sides of said plate and forming a plurality of oppositely paired vertical arms, each vertical arm extending towards said lower mold portion, each vertical arm having a terminal portion having a guide, each pair of oppositely paired vertical arms together forming an aligned pair of guides, each aligned pair of guides being dimensioned to receive reversibly a lateral arm there-through;
b. attaching preconfigured inserts into said lower mold portion into the flange portions of said lower mold portion;
c. introducing a molten composite polymeric material onto said interior surface of said lower mold portion;
d. pressing said upper mold portion and said lower mold portion together by means of said press, and compressing said molten composite polymeric material between said interior surface of said upper mold portion and said interior surface of said lower mold portion, said guide of each vertical arm concurrently being positioned beyond said outside the press lower mold portion exterior surface;
e. inserting said lateral arm through each aligned pair of guides;
f. expanding each expandable member resulting in said plate moving away from said outside the press upper mold portion exterior surface and each lateral arm being brought into compressive contact with said outside the press lower mold portion exterior surface, and correspondingly compressing further said molten composite polymeric material residing within said outside the press internal mold space, thereby forming said molded article.

7. The method of claim 7 wherein each expandable member is an expandable pillow interposed between said second surface of said plate and said outside the press upper mold portion exterior surface.

8. The method of claim 7 wherein each expandable member is an expandable tube interposed between said second surface of said plate and said outside the press upper mold portion exterior surface.
